(19) United States
(12) Patent Application Publication
(10) Pub. No.: US 2002/0195795 A1
(43) Pub. Date: Dec. 26, 2002

(54) Vehicle with trailer

(76) Inventor: David John Bowes Brown, Thirsk (GB)

Correspondence Address: Levisohn, Lerner, Berger & Langsam, LLP, 25th Floor, 757 Third Avenue, New York, NY, 10017, US

(21) Appl. No.: 10/139,108

(22) Filed: May 3, 2002

(30) Foreign Application Priority Data
May 3, 2001 (GB) 0110892.7
Sep. 10, 2001 (GB) 0121853.6

(51) Int. Cl. B60D 1/00

(52) U.S. Cl. 280/492; 180/14.4

(57) ABSTRACT

A connecting section (3) is connected to the tractor (1) and trailer (2) so as to allow pivoting about a transverse axis (26), and the rearward end part (33) of the connecting section (3) is connected to the forward end part (13) so as to be pivotable about a vertical axis (38). The rearward end part (33) is additionally pivotable about a longitudinal axis (34).

### FIELD OF THE INVENTION

This invention relates to articulated vehicles which comprise a tractor and a trailer.

### SUMMARY OF THE INVENTION

The present invention provides a tractor unit having a chassis, an engine and transmission, and front and rear axles, a trailer unit having a chassis and at least front and rear axles, the trailer unit being spaced rearwardly of the tractor unit and a connecting section which connects the tractor chassis and the trailer chassis together, the connecting section having a forward end part and a rearward end part which are connected to the respective chassis and which are connected together so as to be pivotable about a vertical axis, at least one of the said end parts being connected to the associated chassis so as to be pivotable about a transverse axis spaced from the said vertical axis.

Preferably the trailer unit can rotate from side to side about the center-line of a bearing in the connecting section.

In one embodiment of articulated vehicle the forward part of the connecting section is linked to the tractor chassis by one or more hydraulic piston-and-cylinder devices for controlling the load on an axle of the tractor unit.

The rear axle of the tractor unit is preferably connected to the front axle of the trailer unit by a series of drive shafts arranged in such a manner that, at all angles between the tractor unit and the parts of the connecting section and the trailer unit, the drive shafts maintain constant velocity.

One or more of the axles of the trailer unit may be driven from the engine and transmission located in the tractor unit.

A hydraulic piston-and-cylinder accumulator may be connected to pivots forward and rearward of the vertical pivot axis between the forward and rearward parts of the connecting section. The force exerted on the accumulator when the distance between the said pivots shortens (during turning of the vehicle) pressurises a gas in the accumulator, thereby counteracting the tendency of the trailer to travel in a straight line and reducing the steering force needed to return the articulated vehicle to a straight line after turning.

In another embodiment a tractor unit is connected to a driven trailer unit through a transverse pivot on the tractor chassis and a transverse pivot on the trailer chassis pivotally connected to a connecting section which has a vertical pivot in a mid position. Preferably the rear portion the rearward part of the connecting section can rotate longitudinally from side to side about the center-line of a bearing.

In a preferred embodiment the tractor and trailer chassis are each connected by hydraulic cylinders to each adjacent part of the connecting section, thereby enabling weight transfer and pitch damping between tractor and trailer units. Two hydraulic cylinders are pivotally connected on either side of the center-line of the connecting section at one end to the forward part and to a non-rotating portion of the rearward part. The cylinders are each individually connected to a hydraulic accumulator. During turning, the cylinders displace oil into the respective accumulator, thereby increasing the pressure and thus exerting a force to return the vehicle to a straight line.

In a preferred embodiment the rear axle of the tractor unit or a transfer gear box on the tractor unit is connected to the leading axle on the trailer unit and any additional axles by three drive shafts supported by two bearings in such a manner that, at all angles between tractor unit and trailer unit, the drive shafts maintain constant velocity during up and down movement of the tractor and trailer units and steering movement and rotational movement.

### BRIEF DESCRIPTION OF THE DRAWINGS

FIG. 1 is a side elevation of a first embodiment of an articulated vehicle;

FIG. 2 is an enlargement of the detail II in FIG. 1;

FIG. 3 is an enlargement of the detail III in FIG. 1;

FIGS. 4A and 4B are views similar to FIG. 1, but showing the respective extremes of relative inclination of a tractor and a trailer;

FIG. 5 is a plan view of the first embodiment of the vehicle, when turning;

FIG. 6 is an enlargement of the detail VI in FIG. 5;

FIG. 7 is a view similar to FIG. 1, but showing the trailer tilted sideways relative to the tractor;

FIG. 8 is a rear end view of the vehicle as shown in FIG. 7;

FIG. 9 is a side elevation of a second embodiment of the articulated vehicle;

FIG. 10 is a plan view, partly in phantom, corresponding to FIG. 9;

FIGS. 11A and 11B are views similar to FIG. 9, but showing the respective extremes of relative inclination of the tractor and the trailer;

FIG. 12 is a plan view of the second embodiment of the vehicle;

FIG. 13 is an enlargement of the detail XIII in FIG. 12;

FIG. 14 is a view similar to FIG. 9, but showing the trailer tilted sideways relative to the tractor;

FIG. 15 is an enlargement of the detail XV in FIG. 14;

FIG. 16 is a rear end view corresponding to FIG. 14;

FIG. 17 is a side elevation of a third embodiment of the articulated vehicle, with the trailer rotated about a longitudinal axis;

FIG. 18 is a rear view corresponding to FIG. 17;

FIG. 19 is an enlargement of the detail XIX in FIG. 17;

FIG. 20 is a side elevation with the trailer below the horizontal of the tractor;

FIG. 21 is an enlargement of the detail XXI in FIG. 20;

FIG. 22 is a side elevation with the trailer above the horizontal of the tractor;

FIG. 23 is an enlargement of the detail XXIII in FIG. 22;

FIG. 24 is a plan view of the vehicle showing the turning angle between tractor and trailer; and

FIG. 25 is an enlargement of the detail XXV in FIG. 24, showing a steering linkage.

### DETAILED DESCRIPTION OF THE PREFERRED EMBODIMENTS

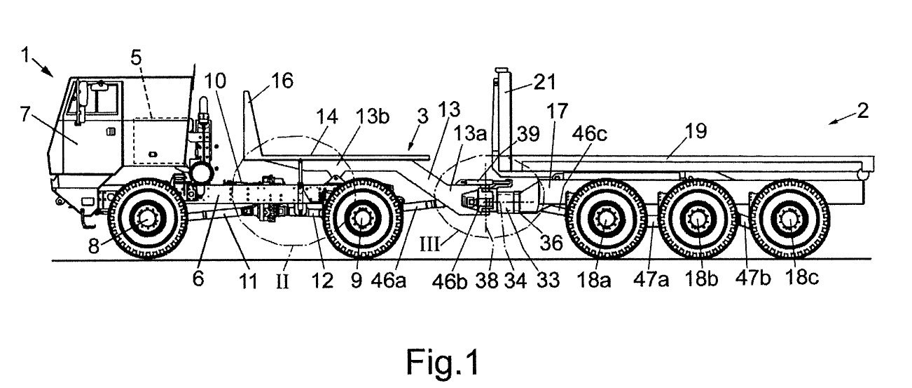

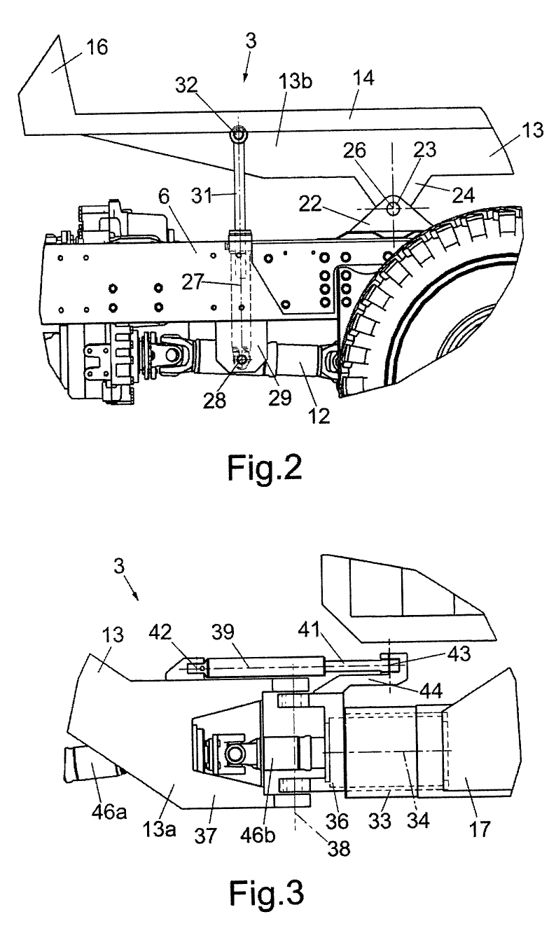

The articulated vehicle shown in FIGS. 1 to 8 comprises a leading steerable unit or tractor 1 and a trailing unit or trailer 2 which are connected by a connecting section 3. The tractor 1 has a chassis 6 which mounts a cab 7, an engine 5 and transmission 10, a steerable front axle 8, and a fixed rear axle 9, both axles 8,9 being driven from the transmission via respective cardan shafts 11,12.

The connecting section 3 of the trailer 2 has a forward end part or frame 13 with a rear portion 13a, which lies behind the tractor 1 and is at approximately the same level as the chassis 6, and a front portion 13b which extends over the chassis 6 and carries a load-carrying body comprising a flat bed 14 and a headboard 16. The trailer 2 has a chassis 17 which is approximately at the same level as the rear portion 13a of the frame 13 and which mounts three drivable axles (18a, 18b, 18c) and a load-carrying body comprising a flat bed 19 and a headboard 21.

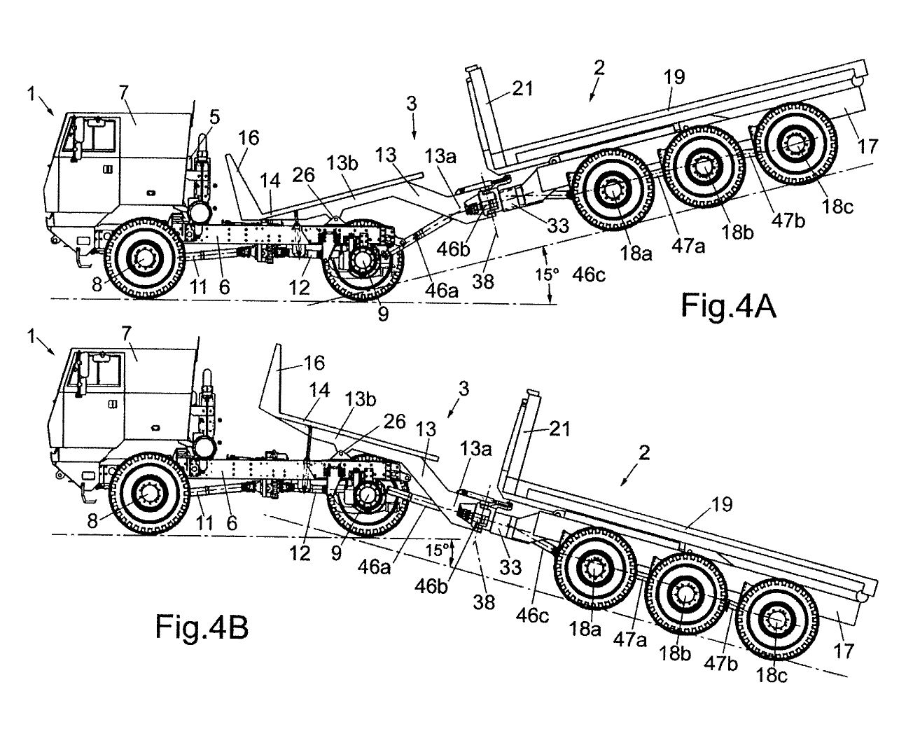

The chassis 6 of the tractor 1 has brackets 22 supporting mutually aligned transverse pivot pins 23 which in turn support respective brackets 24 integral with the front portion 13b of the frame 13 so that the connecting section 3 is pivotable about a transverse axis 26 ahead of the rear axle 9 of the tractor 1. The size of the brackets 22,24 and the relative spacing of the chassis 6,13 allow the trailer 2 to be inclined upwards and downwards relative to the tractor 1 by an angle of up to 15°, for example, as shown in FIGS. 4A and 4B. On each side of the center line of the tractor 1 a hydraulic cylinder 27 has its lower end connected by a pivot 28 to a frame member 29 rigid with the chassis 6, while a piston 31 extends from the other end of the cylinder 27 and has its free end connected by a pivot 32 to a frame member of the connecting section 3. The cylinders 27 can be used to apply to the chassis 6 of the tractor 1 a moment of force (relative to the trailer) acting about the transverse axis 26 in order to control the load acting on the rear axle 9 of the tractor 1. The cylinders 27 also damp oscillation about the transverse axis 26.

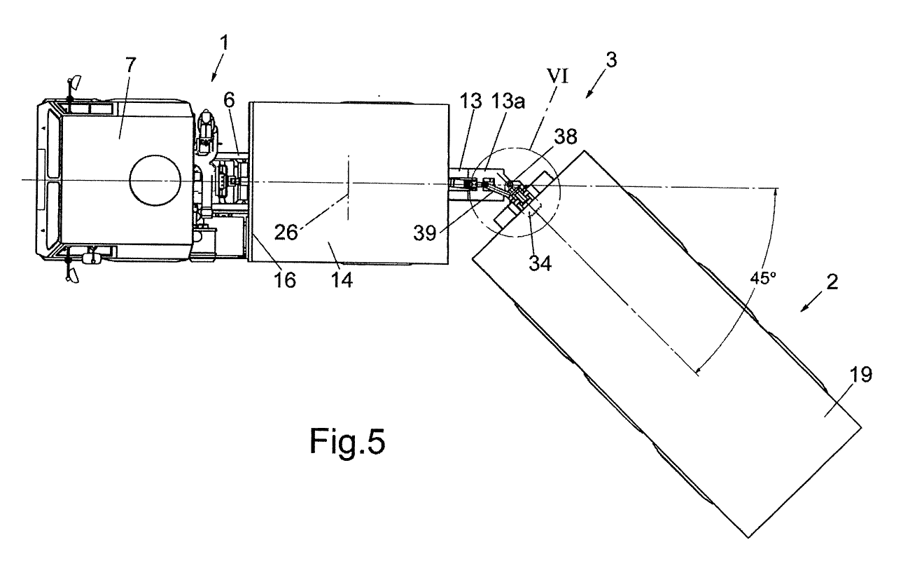

The front end of the trailer chassis 17 carries an annular bearing member 33 forming the rearward end part of the connecting section 3, defining a longitudinal axis 34 and supporting a rear hinge member 36 of the connecting section 3, for rotation about the axis 34. The hinge member 36 is connected to a front hinge member 37 (integral with the rear portion 13a of the frame 13) so as to be pivotable about a vertical axis 38. The hinge (36,37) allows the trailer 2 to pivot through an angle of up to 45°, for example, relative to the tractor 1, as shown in FIG. 5. The bearing (33) allows the trailer 2 to tilt sideways, in both directions, through an angle of up to 30° or more, for example, as shown in FIGS. 7 and 8.

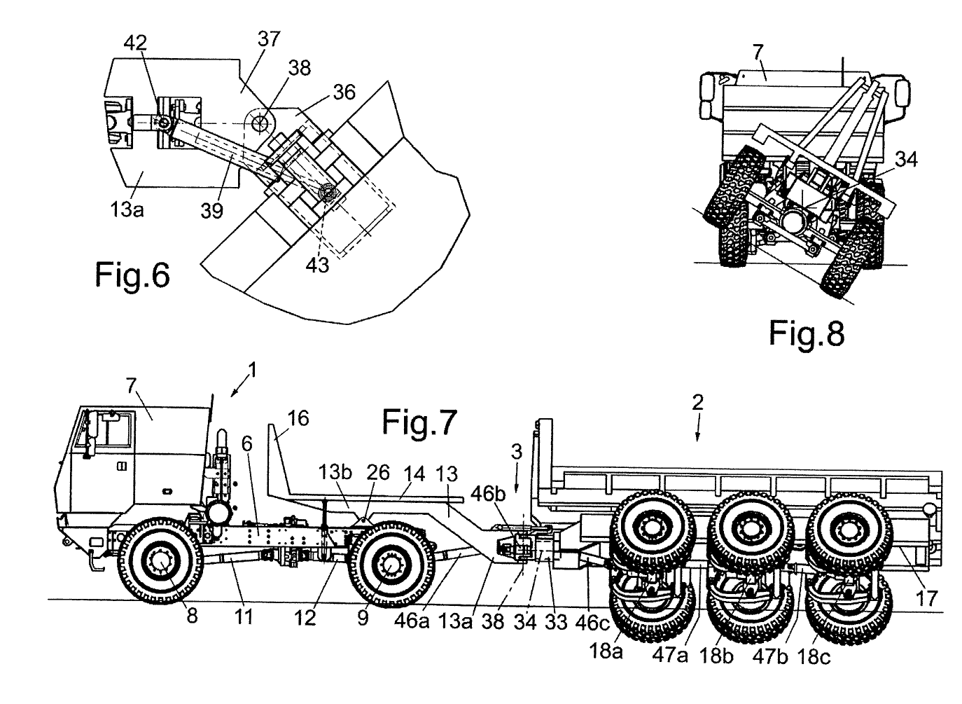

An accumulator comprising a hydraulic cylinder 39 with a piston 41 has one end connected to the rear portion 13a of the frame 13 by a pivot 42 in front of the vertical axis 38 and has the other end connected to a rearward extension 44 of the rear hinge member 36 by a pivot 43 behind the vertical axis 38. When the distance between the pivots 42,43 shortens during turning of the vehicle, as shown in FIGS. 5 and 6, the piston 41 pressurises nitrogen (or another gas) in an accumulation chamber in the cylinder 39. This pressure constitutes potential energy which is generated and stored by the cylinder 39 in response to changes in the angle between the center lines of the rearward and forward parts of the connection section 3, due to relative turning of the parts about the vertical axis 38. As the angle increases, energy (in the form of pressure) is generated and stored and the angular increase is resisted; this counteracts the tendency of the trailer 2 to travel in a straight line. As the angle decreases, the stored pressure acts on the piston 41 so as to assist the angular decrease, thereby reducing the steering force needed to return the articulated vehicle to a straight line after turning.

Drive is transferred from the rear axle 9 of the tractor 1 to the front axle 18a of the rearward section 4 by a series of drive shafts 46a,46b,46c which maintain constant velocity transmission of rotation between the respective axles 9,18a at all angles between the tractor 1, the connecting section 3, and the trailer 2. The axles 18a,18b,18c of the trailer 2 are connected for rotation by drive shafts 47a,47b. Thus all the wheels of the vehicle are driven from the engine 5 and transmission 10 located in the tractor 1.

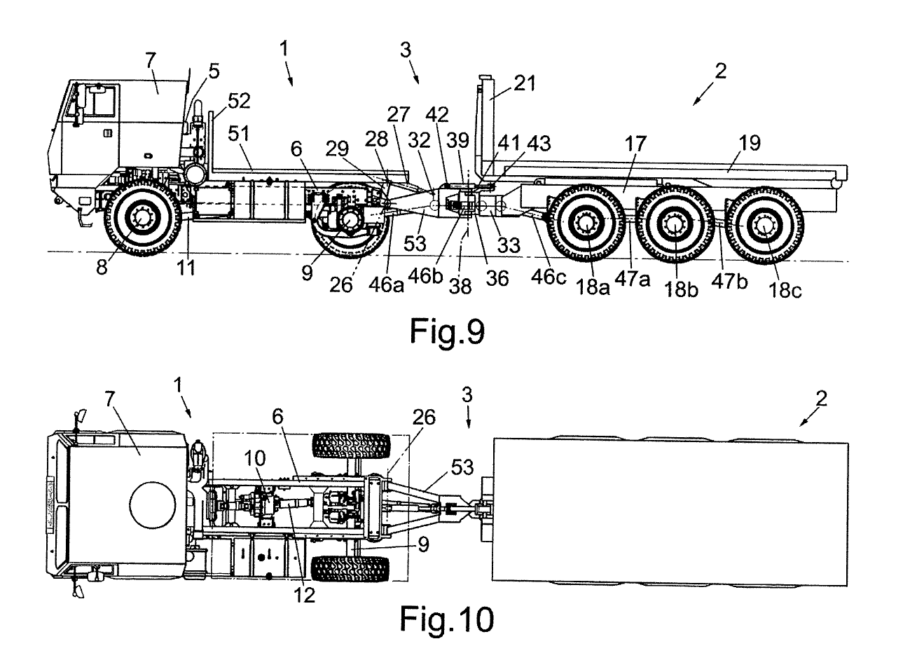

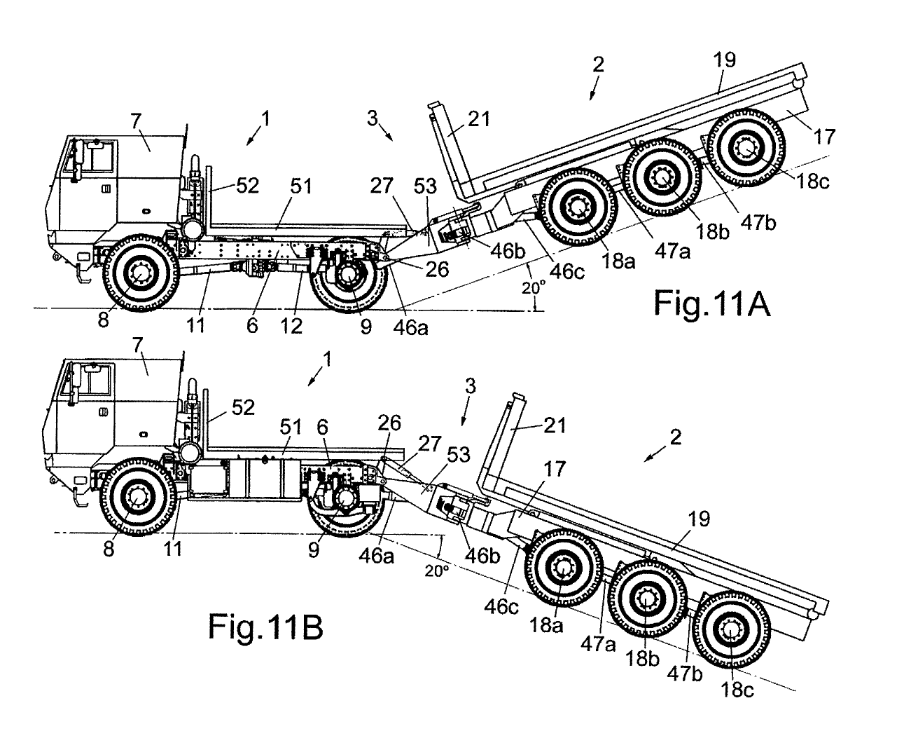

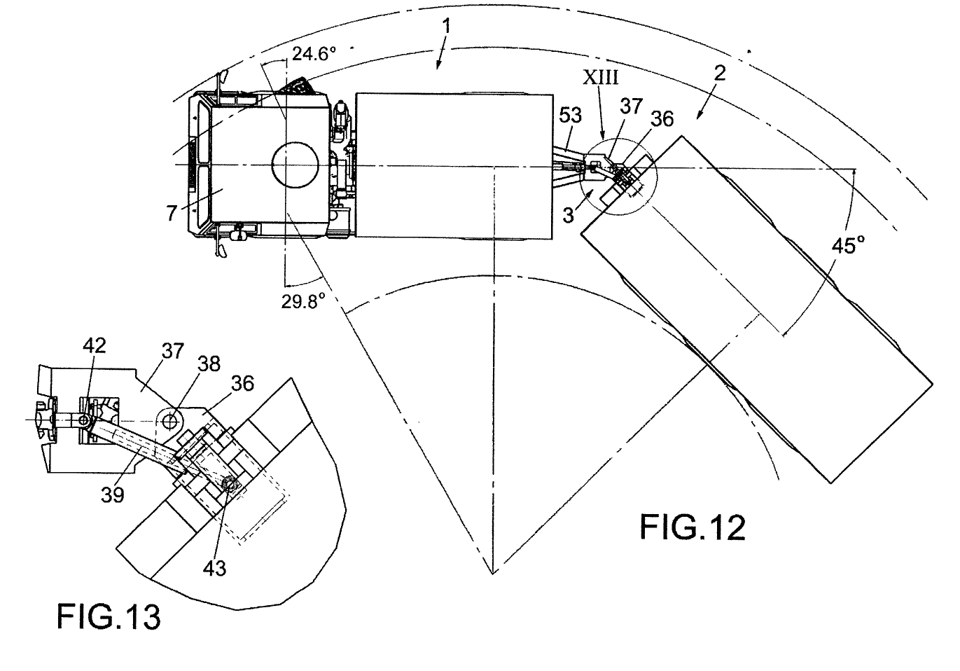

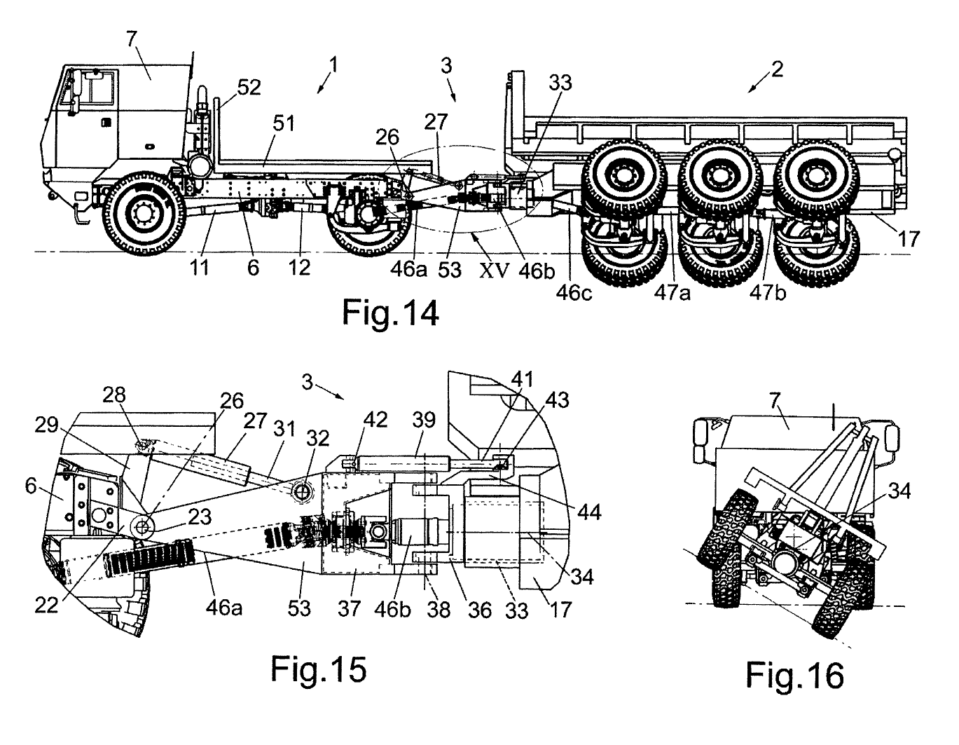

The second embodiment of the articulated vehicle, shown in FIGS. 9 to 16, is similar to the first embodiment, and only the differences will be specifically described. The tractor 1 has a load-carrying body comprising a flat bed 51 and a headboard 52, mounted on the chassis 6. The connecting section 3 comprises a forward end part or frame 53 which is approximately level with the chassis 6 of the tractor 1 and the chassis 17 of the trailer 2 and which has front end portions connected to the rear end of the chassis 6 so as to allow pivoting about the transverse axis 26, which in this embodiment lies behind the rear axle 9 of the tractor 1. The rear end of the frame 53 is provided with the above-mentioned front hinge member 37. The above-described piston-and-cylinder device (27, 31) for controlling the load on the rear axle 9 of the tractor 1 (and damping oscillation) is connected between a frame member 29 rigid with the rear end of the chassis 6 and the frame 53 (FIG. 15). As shown in FIGS. 11A and 11B, the maximum angle of relative inclination of the tractor 1 and trailer 2 can be somewhat greater in this embodiment, for example, up to 20°.

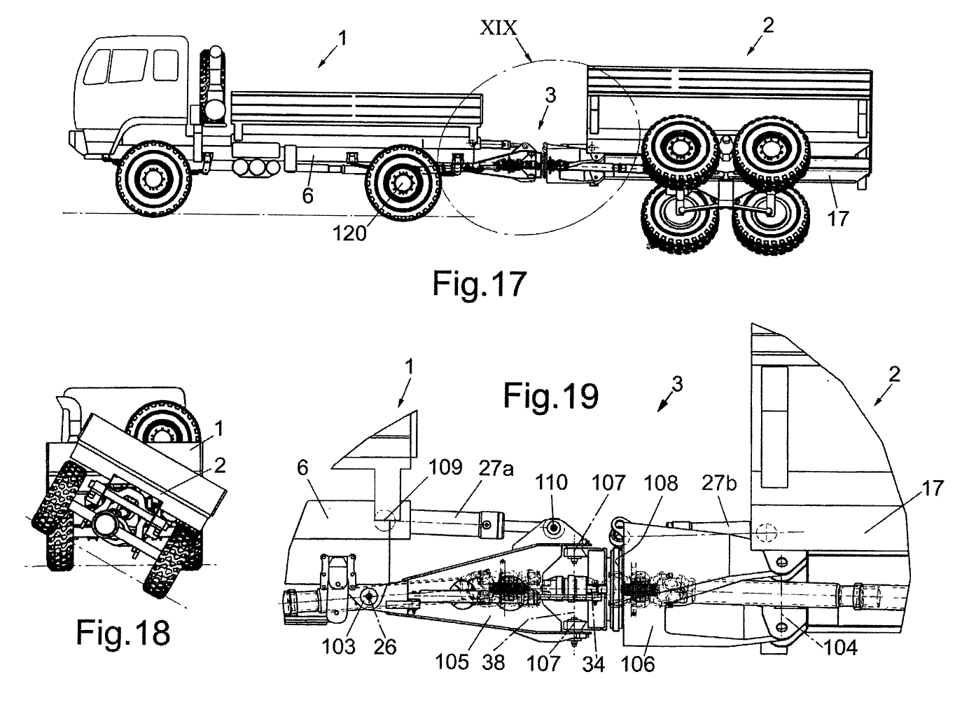

The third embodiment of the articulated vehicle is shown in FIGS. 17 to 25.

Referring to FIGS. 17 to 19, the tractor 1 is connected to the trailer 2 by a center section or connecting section 3 which is connected by a transverse pivot 103 (axis 26) on the tractor chassis 6 and by a transverse pivot 104 on the trailer chassis 17. The centre section 3 has a forward end part 105 connected to a rearward end part 106 by a vertical pivot 107 (axis 38) and a longitudinal pivot (bearing) 108 (axis 34).

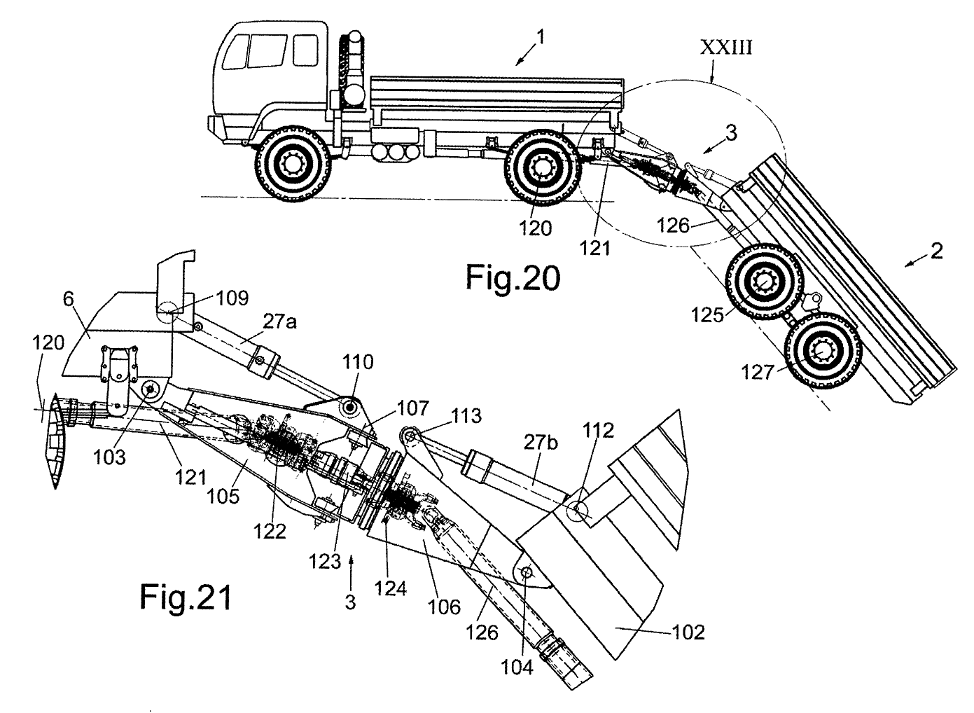

FIGS. 17 and 18 show how the trailer 2 can tilt about a longitudinal axis relative to the tractor 1. FIG. 20 shows the trailer 2 rotated downwards relative to the tractor 1.

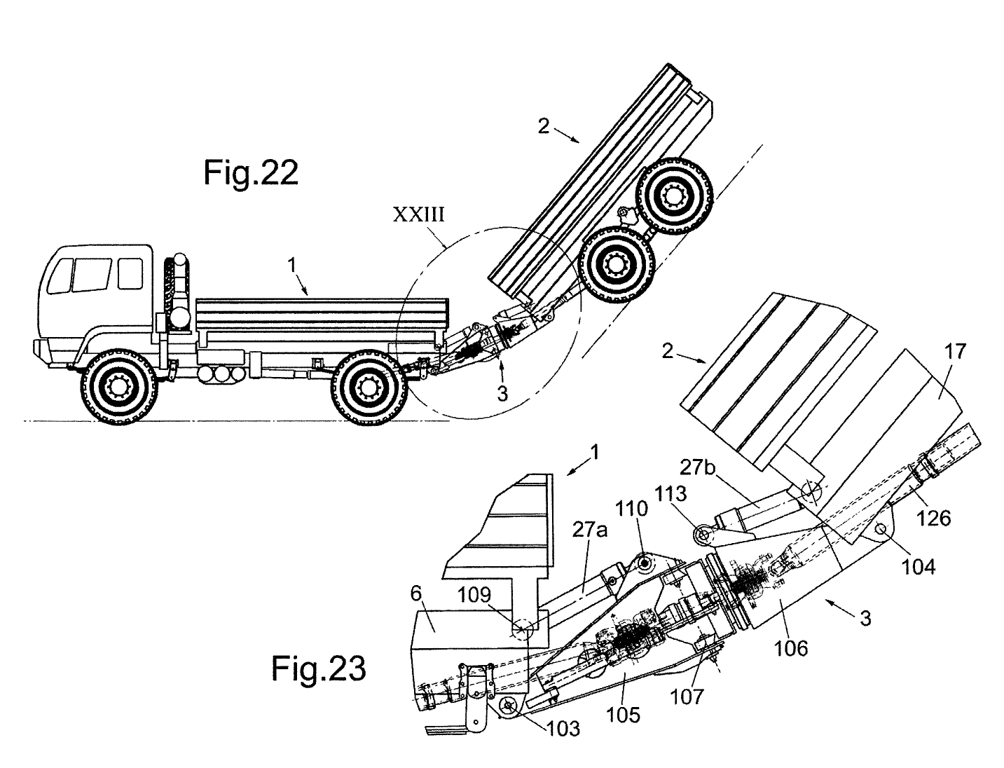

FIG. 21 shows the center section 3 (105,106) rotated downwards about the pivot 103 and the trailer 2 rotated downward about the pivot 104. A hydraulic cylinder 27a is connected at one end to the tractor chassis 6 at a pivot 109 and to the forward part 105 of the center section 3 at a pivot 110. A second hydraulic cylinder 27b is connected to the trailer chassis 17 at a pivot 112 and to the rearward part 106 of the center section 3 at a pivot 113. Angular movement up or down of the trailer 2 lengthens or shortens the hydraulic cylinders 27a and 27b enabling weight transfer and a damping of tractor-to-trailer nodding forces. FIG. 22 shows the upward movement of the trailer 2 in relation to the tractor 1. FIG. 23 shows the corresponding pivotal details. Downward movement of the trailer 2 causes the cylinder 27b to extend as in FIG. 21. Upward movement causes it to retract as in FIG. 23.

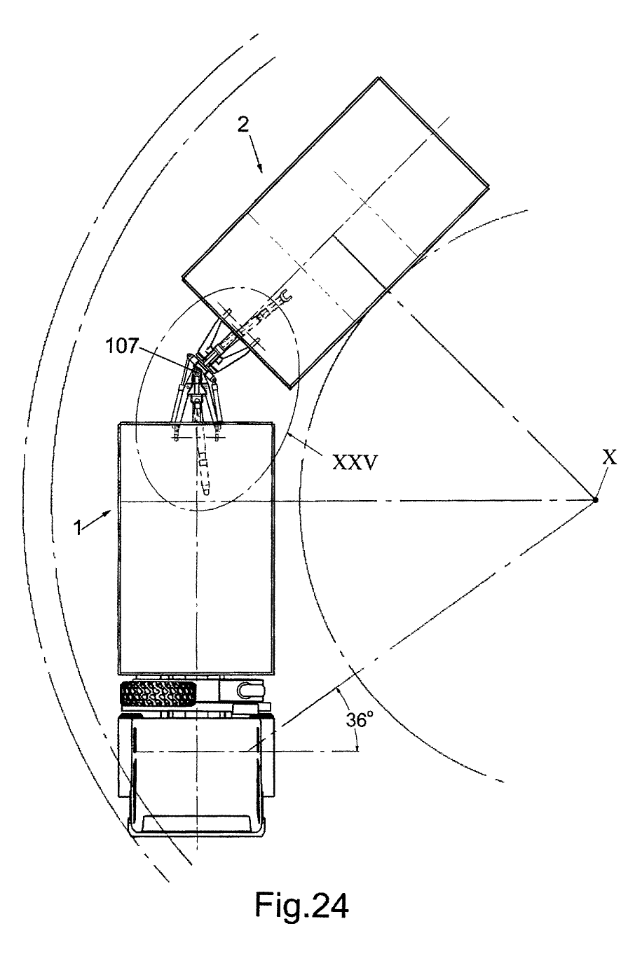

FIG. 24 shows the tractor 1 with the trailer 2 rotated about the vertical pivot 107 so as to allow the combination to turn about an axis X.

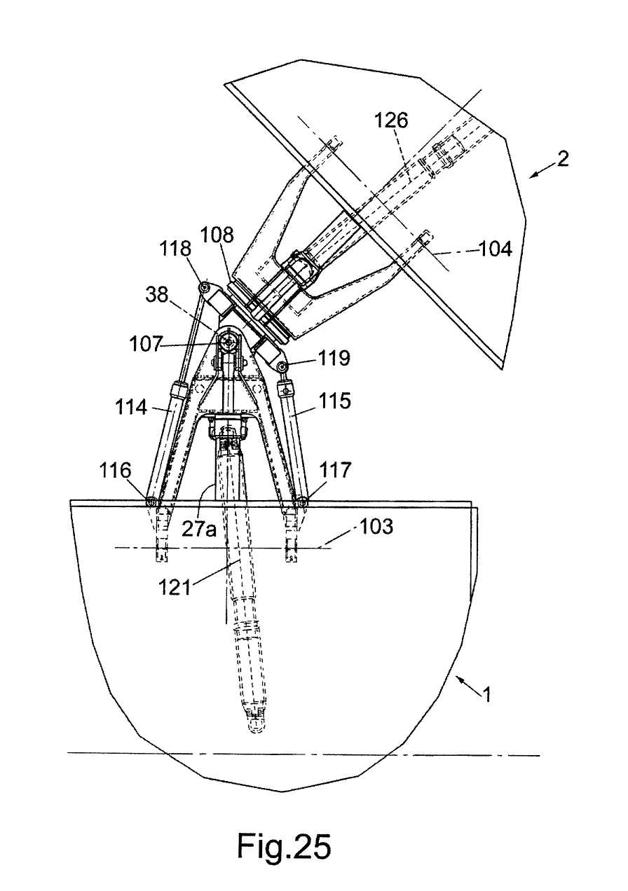

Two hydraulic cylinders 114 and 115 (accumulators) are connected to the forward part 105 of the center section 3 at pivots 116 and 117 and at their other end are connected at pivots 118 and 119 to the front (non-rotating) portion of the bearing 108. Referring to FIG. 25, turning the tractor 1 in relation to the trailer 2 has compressed a gas in cylinder 115 and expanded a gas in cylinder 114, thereby giving a corrective steering force to assist the steering wheels on the tractor 1 to overcome the straight-line effect of the trailer tandem axles. As the vehicle approaches the straight ahead condition the corrective forces are equalised.

Drive for the tractor 1 is transmitted from an output on a transfer gearbox or (as shown) from the rearmost axle 120 via a drive shaft 121 to a bearing 122 located in the forward part 105 of the center section 3 connected to a drive shaft 123 supported at its other end by a bearing 124 which is equidistant from the pivot 107 with bearing 122. The drive is continued to the leading trailer axle 125 by a drive shaft 126. Any additional axles 127 are driven from the leading trailer axle 125.

I claim:

1. An articulated vehicle comprising
a tractor unit having a chassis, an engine and transmission, and front and rear axles;
a trailer unit having a chassis and at least front and rear axles, the trailer unit being spaced rearwardly of the tractor unit; and
a connecting section which connects the tractor chassis and the trailer chassis together, the connecting section having a forward end part and a rearward end part which are connected to the respective chassis and which are connected together so as to be pivotable about a vertical axis, at least one of said end parts being connected to the associated chassis so as to be pivotable about a transverse axis spaced from said vertical axis.

2. An articulated vehicle as claimed in claim 1, in which said end parts are connected together so as to be additionally pivotable about a longitudinal axis relative to each other.

3. An articulated vehicle as claimed in claim 2, in which said end parts are connected by a bearing defining said longitudinal axis, the bearing being rearward of said vertical axis.

4. An articulated vehicle as claimed in claim 1, further comprising a pivoting control device which controls pivoting about said transverse axis.

5. An articulated vehicle as claimed in claim 4, in which the pivoting control device comprises at least one piston-and-cylinder device.

6. An articulated vehicle as claimed in claim 4, in which the pivoting control device is capable of applying to the tractor chassis a moment of force about said transverse axis.

7. An articulated vehicle as claimed in claims 4, in which the pivoting control device is capable of damping oscillation about said transverse axis.

8. An articulated vehicle as claimed in claim 1, in which said forward end part is connected to the tractor chassis by a transverse pivot.

9. An articulated vehicle as claimed in claim 8, in which said rearward end part is connected to the trailer by a transverse pivot.

10. An articulated vehicle as claimed in claim 1, in which the trailer front axle is kinematically connected to the transmission by a series of drive shafts that maintain constant velocity transmission of rotation at all angles between the tractor unit and the trailer unit.

11. An articulated vehicle as claimed in claim 1, including an energy generation and storage system responsive to changes in angle between center-lines of said end parts of the connecting section due to relative turning of said end parts about said vertical axis, such that, as the angle increases, energy is generated and stored and the angular increase is resisted, and, as the angle decreases, stored energy is released and the angular decrease is assisted.

12. An articulated vehicle as claimed in claim 11, in which said system comprises a pressure accumulator.

13. An articulated vehicle as claimed in claim 1, in which said forward end part of the connecting section has a frame which extends forwardly of said transverse axis, above a rear part of the tractor chassis.

14. An articulated vehicle as claimed in claim 13, further comprising a load-carrying body mounted on the frame.

15. An articulated vehicle as claimed in claim 1, in which the tractor unit has a load-carrying body, said forward end part of the connecting section being connected to a rear end of the tractor chassis.
